(19) United States
(12) Patent Application Publication
(10) Pub. No.: US 2021/0309311 A1
(43) Pub. Date: Oct. 7, 2021

(54) Seat Preclusion to Avoid Unauthorized Mounting on a Two-Wheeler

(71) Applicant: Paul Batushansky, Brooklyn, NY (US)

(72) Inventor: Paul Batushansky, Brooklyn, NY (US)

(21) Appl. No.: 17/345,568

(22) Filed: Jun. 11, 2021

Related U.S. Application Data
(63) Continuation-in-part of application No. 16/700,994, filed on Dec. 2, 2019.

(51) Int. Cl. B62H 5/00

(52) U.S. Cl. CPC B62H 5/006

(57) ABSTRACT

A two-wheeler mount preclusion apparatus comprising: a saddle-post block coupling a saddle with a post; a point of articulation disposed on the block; and a tool of manipulation at the point of articulation of said block, when manipulated, allowing for at least a degree of rotation of the saddle, wherein the rotation of the saddle renders the two-wheeler into a mount-precluded state.

The invention pertains generally to the field of motorcycle accessories, and more particularly to a motorcycle accessory preventing unauthorized users from sitting, mounting, or straddling (mounter) a stationary two-wheel conveyance (bicycle, electric motored bike, motorcycle, etc.).

### BACKGROUND OF INVENTION

Based on the most current estimates, there are an estimated 6-8 million registered motorcyclists in the United States. This figure is proportionately even larger in foreign countries that suffer from crippling congestion and poor infrastructure, such as South Asia and Latin America. The same factors that increase the risk of fatalities—open to the environment—also render stationary motorcycles vulnerable to being tampered with by a strange passer-by. The one thing that all 8 million registered motorcyclists have in common is that they tend to be passionate—if not obsessive—regarding their motorcycles. According to a recent poll, motorcycle (bike) enthusiasts are in consensus that they deem strangers sitting, mounting, or straddling (mounters) on their parked bikes as the biggest nuisance.

Beyond just a nuisance, there are significant injury risks to the mounter, not to mention significant risk of liability to the motorcycle owner. Many bikes can be dropped, bringing the mounter down to the ground, or worse, drop on top of the mounter. Also, a mounter may burn his inner thigh or calf on the hot exhaust or engine. This is especially true in the case of children mounting a bike. Aside from the risk of injury or liability, dropping a bike can result in thousands of dollars of damages. In fact, it is not rare for an insurance company to completely write-off drop-related body damages since repairing it would cost more than 75% of the current value of the bike. What's more, most mounter's can't resist turning the throttle while mounting the bike (sound effects optional), often leading to a flooded engine and subsequent ignition issues.

Despite the risk and nuisance posed by mounting a stationary bike, there is currently a void in the market for deterring such behavior. Harley Davidson has recently launched a series of motorcycles that are communicatively coupled to a personalized key fob, whereby when motion or pressure sensors on the motorcycle are triggered in the absence of the key fob, the motorcycle is commanded to trigger an alarm. While this alarm system may incentivize a mounter to remove oneself from the Harley, it does not create any deterrence from mounting the motorcycle in the first place. All of the above mentioned risks may occur immediately after mounting and before the mounter has had a chance to get off. As a matter of fact, the blaring sounds of the alarm may have the unintended effect of exacerbating the mentioned risks due to the alarmed and panicked state of the mounter upon hearing the alarm. Thus, there is a need for a product that deters a mounter from mounting a motorcycle, while the motorcycle is stationary and unattended.

Furthermore, as the bike boom sweeps across the nation, and the world for that matter, municipalities everywhere are aggressively interconnecting their cities with a vast bikeshare network. In a matter of less than a decade, there are approximately 119 U.S. cities with a bikeshare program, including for 4,789 docks, amounting to 84 million rides as of 2018, according to The National Association of City Transport Officials (NACTO). This bike boom doesn't show any signs of slowing as ridership records are being set in the largest urban centers. In New York City for instance, 671,714 rides on CitiBike in one early spring week set the largest weekly ridership ever recorded for the bike share program, based on reports from NYC's Department of Transportation. In NYC, officials—policy-makers in collaboration with the private sector—are responding to this trend towards micro-mobility by earmarking large capital investments in expanding the network, while maintaining rider safety. The ride-share service Lyft has recently pledged a $100 million investment in doubling NYC's bikeshare footprint with new bikes, dock, and bike lanes. In parallel, the electric scooter footprint has become noticeably larger with the debut of Lime and Revel in NYC.

Evidently, the capital outlay does not involve reengineering or redesigning the fleet of bikes/scooters. The last major attempt for any bike/fleet improvement in NYC was 2015, when bike advocates pressured designers to improve gear shifting, create a sturdier bike stand, and quicker water-draining seat. The safety risk posed from the growing issue of unauthorized seat mounting of available bikes/scooters—especially undocked—has yet to be addressed. There has yet to be any structural element/mechanism, as part of the bike itself, to prevent or deter unauthorized seat mounting. The cities dockless offering is sure to expand during this boom, especially given the cities voracious micro-mobility demand and the cities expense involved in building docks, which comprises a considerable amount of tech and construction-intensive labor—not to mention a loss of revenue-generating parking space in some cases.

As previously mentioned, there are significant injury risks to the mounter of a dockless and stationary bike, not to mention significant risk of liability to the city. Many bikes can be dropped, bringing the mounter down to the ground, or worse, drop on top of the mounter. In addition to bikes as part of a ride-share program, there are also 8 million registered private bike owners exposed to liability related to a mounter burning his/her inner thigh or calf on the hot exhaust or engine. This is especially true in the case of children or intoxicated adults mounting a bike. Aside from the risk of injury or liability, dropping a bike can result in thousands of dollars of damages—not good, in particular if you are one of the 8 million registered private bike owners. There is clearly a void in the market for an integrated or after-market installed seat preclusion element to avoid unauthorized mounting of private bikes and undocked city bikes alike.

### SUMMARY

The invention resides in enabling a motorcyclist to deter and prevent an unauthorized user from sitting, mounting or straddling (mounter) the motorcycle, while the motorcycle is stationary and unattended—in order to reduce the risks inherent in straddling.

Advantageously, unlike the Harley Davidson key fob-mediated alarm system, there is no need for electronics or short-range electronic communication in order to deter the mounting. Moreover, beyond providing for a deterrence for mounting, the invention doubles as a useful back-pack while in operation. The invention provides for the deterrence by forming a hump over the seat from the storage of a helmet—or any other motorcycle accessory—while stationary.

It is one object of the present disclosure to provide an apparatus for providing a motorcycle mount deterrence comprising: a back-pack of foldable material with a back surface, a front surface, one side, another side, a slit on each side, a bottom surface, a top surface with a draw-string opening for accessing at least one compartment, and at least one over-the-shoulder strap disposed on the back surface; said back-pack with the draw-string un-drawn and said back-pack back surface to rest on a top surface of a seat of the motorcycle, wherein the back-pack back surface covers the top surface of the seat of the motorcycle; a first strap affixed proximal to a first side of the seat of the motorcycle and said first strap terminating with a hook and a second strap affixed proximal to a second side of the seat of the motorcycle and said second strap terminating with a buckle; each of the first strap and second strap inserted through each of the slits disposed on each of the sides of the back-pack gaining access into the at least one compartment of the back-pack and the hook of the first strap hooked into the buckle of the second strap by access through the un-drawn top opening of the back-pack; and draw the top portion of the back-pack closed and lock the top portion closed securing the back-pack housing the helmet on the seat of the motorcycle in an unattended state and deterring unauthorized mounting of the motorcycle and restricting access into the compartment for access to at least one of the helmet and/or buckles for un-buckling the straps and removing the back-pack from the seat of the motorcycle by anyone unauthorized.

It is another object of the present disclosure to provide for an apparatus preventing unauthorized mounting of a motorcycle, said apparatus comprising: a first strap affixed proximal to a first side of a seat of the motorcycle and said first strap terminating with a hook and a second strap affixed proximal to a second side of the seat of the motorcycle and said second strap terminating with a buckle; each of the first strap and second strap inserted through each of a slit disposed on each side of a back-pack gaining access into at least one compartment of the back-pack and the hook of the first strap hooked into the buckle of the second strap by access through an un-drawn top opening of the back-pack; and draw the top portion of the back-pack closed and lock the top portion closed securing the back-pack housing a helmet on the seat of the motorcycle in an unattended state and deterring unauthorized mounting of the motorcycle and restricting access into the compartment for access to at least one of the helmet and/or buckles for un-buckling the straps and removing the back-pack from the seat of the motorcycle by anyone unauthorized.

It is yet another object to provide for a method for preventing unauthorized mounting of a motorcycle, comprising the steps of: affixing a first strap proximal to a first side of a seat of the motorcycle and said first strap terminating with a hook and affixing a second strap proximal to a second side of the seat of the motorcycle and said second strap terminating with a buckle; inserting each of the first strap and second strap through each of a slit disposed on each side of a back-pack gaining access into at least one compartment of the back-pack and hooking the first strap into the buckle of the second strap by accessing through an un-drawn top opening of the back-pack; and drawing the top opening of the back-pack closed and lock the top portion closed securing the back-pack housing the helmet on the seat of the motorcycle in an unattended state and deterring unauthorized mounting of the motorcycle.

In light of the micro-mobility trend sweeping across cities, it is another object to provide an apparatus that deters seat mounting across all two-wheeler modalities—either as an integrated element, after-factory fitting, or user-installed. One potential embodiment allows for stationary and dockless bicycles to fold down the saddle preventing unauthorized mounting simply by a saddle block being configured with two hinged elements enabling the saddle-facing element to pivot down. In another embodiment, the bicycle saddle block may pivot at a point between the saddle block and the saddle post, and thereby enabling a user to fold down the saddle into a mount-deterred state. In the case of mopeds, mount deterrence may be accomplished by having an articulating trunk brace that allows for the trunk to fold over the seat while the moped is in a stationary position. Likewise, in the case of the cruiser, a rear fender may articulate upward to block unauthorized mounting; or the cruiser saddle may articulate upward to accomplish the same effect. Finally, sportsbikes may have a saddle that slide backward to hide the saddle under the tail of the bike; or the saddle may flip on its axis by having dual rotation points: one between the saddle and tank, and the other between the saddle and the tail of the sportbike. By providing mount deterrence already affixed to the two-wheeler, a user may not have to worry about riding with extra accessories. Furthermore, the affixed mount-deterrence will address the myriad of safety issues arising from the log growth in the number of two-wheelers—across modalities—that is inevitable during this current micro-mobility boom.

### BRIEF DESCRIPTION OF FIGURES

FIG. 1 depicts a top-down view of the back-pack mounted onto a seat of a motorcycle in accordance with an aspect of the invention.

FIG. 2 depicts a side-view of the back-pack mounted onto a seat of a motorcycle in accordance with an aspect of the invention.

FIG. 3 depicts a side-view of the back-pack un-securely mounted onto a seat of the motorcycle in accordance with an aspect of the invention.

FIG. 4 depicts a close-up illustrating how the straps are affixed proximal to a side of a seat in accordance with an aspect of the invention.

FIG. 5 depicts the inner compartment of the back-pack and terminal ends of the straps hooked in place in accordance with an aspect of the invention.

FIG. 6 depicts the back-pack worn over the shoulders of a motorcyclist while the motorcycle is in operation.

FIG. 7 depicts a method flow diagram in accordance with an aspect of the invention.

FIG. 8a depicts a mount deterrence apparatus in accordance with an aspect of the invention.

FIG. 8b depicts a mount deterrence apparatus in accordance with an aspect of the invention.

FIG. 8c depicts a mount deterrence apparatus in accordance with an aspect of the invention.

FIG. 9a depicts a mount deterrence apparatus in accordance with an aspect of the invention.

FIG. 9b depicts a mount deterrence apparatus in accordance with an aspect of the invention.

FIG. 9c depicts a mount deterrence apparatus in accordance with an aspect of the invention.

FIG. 10a depicts a mount deterrence apparatus in accordance with an aspect of the invention.

FIG. 10b depicts a mount deterrence apparatus in accordance with an aspect of the invention.

FIG. 10c depicts a mount deterrence apparatus in accordance with an aspect of the invention.

FIG. 11a depicts a mount deterrence apparatus in accordance with an aspect of the invention.

FIG. 11b depicts a mount deterrence apparatus in accordance with an aspect of the invention.

FIG. 11c depicts a mount deterrence apparatus in accordance with an aspect of the invention.

FIG. 12a depicts a mount deterrence apparatus in accordance with an aspect of the invention.

FIG. 12b depicts a mount deterrence apparatus in accordance with an aspect of the invention.

FIG. 12c depicts a mount deterrence apparatus in accordance with an aspect of the invention.

FIG. 13a depicts a mount deterrence apparatus in accordance with an aspect of the invention.

FIG. 13b depicts a mount deterrence apparatus in accordance with an aspect of the invention.

FIG. 13c depicts a mount deterrence apparatus in accordance with an aspect of the invention.

### DETAILED DESCRIPTION

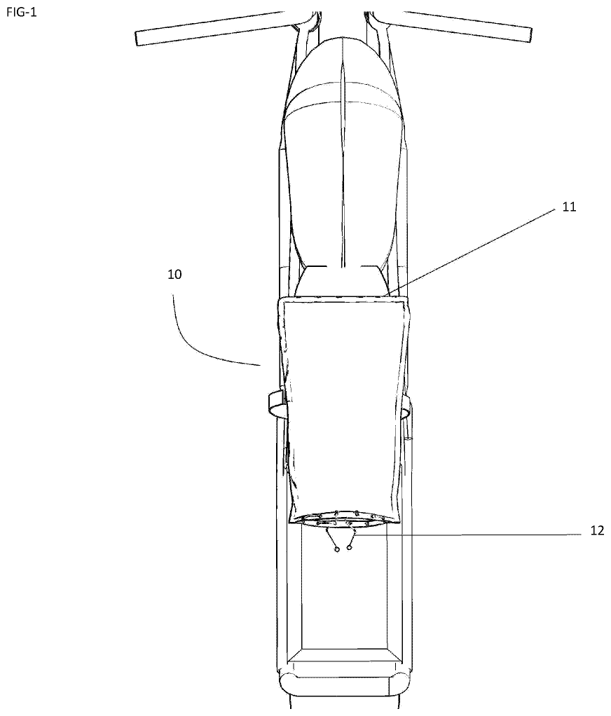

FIG. 1 depicts a top-down view of the back-pack mounted onto a seat of a motorcycle in accordance with an aspect of the invention. As depicted in FIG. 1, the apparatus for providing a mount deterrence may appear as a standard back-pack 10 securely affixed to a top of the seat 11 of a motorcycle, wherein the back-pack back surface is at least partially covering the surface of the seat 11. The affixed back-pack 10 enclosed with a helmet provides the necessary deterrence for mounting the motorcycle. It is conceivable for the back surface of the back-pack 10 to under-cover or over-cover the surface of the seat 11. In the case of under-covering, even if a portion of the seat 11 is exposed, it is in all likelihood still serving as a deterrence for a mounter to mount the motorcycle since the portion exposed is not large enough for a person of average size to sit on. In the case of over-covering, even if a portion of the back-pack 10 is hanging over the edge of the seat 11, since it is securely affixed to the seat, it will still serve as a deterrence to mounting. The size constraints to consider are: The back-pack 10 must be large enough to house a helmet, or optionally, any object large enough to form a hump while housed in the back-pack in order to deter mounting while affixed to the surface of the seat 11; while still being small enough to optionally collapse into a strapped cylinder and worn over the shoulders of a motorcyclist while riding.

As further shown in FIG. 1, the top portion of the back-pack 10 is opened and closed by a drawing or cinching action of a draw-string 12. Once the back-pack 10 is positioned over the seat 11 of the stationary motorcycle, it is un-drawn to open in order to house the helmet of the motorcyclist. While not shown, the back-pack 10 must have at least one large compartment for housing the helmet. Optionally, there may be additional smaller compartments within the interior larger compartment. Alternatively, the exterior surface of the back-pack 10 may have additional compartments that may be accessed from the outside. However, as one can imagine, compartments that may be gained access to from the outside are not ideal since items contained within the outer compartments may be vulnerable to theft while the motorcycle is unattended. Also not shown, the front surface of the back-pack 10 may further comprise side straps with side-release buckles to allow a user to further fold in or collapse the back-pack 10 into a cylinder form for minimizing wind resistance during riding the motorcycle.

The back-pack 10 may take on any one of a style, so long as it is comprised of a form-factor enabling for housing a helmet in the stationary (affixed) state, and collapsible (foldable) into a cylinder-form to be worn over the shoulders of a rider in the ride state. As shown, it is a cinch-draw tote or back-pack 10 with double over-the-shoulder straps. While not shown, internal compartments may house items such as keys or mobile phone. Additionally, while not shown, a zippered bottom surface may be separate from the main helmet-housing compartment and serve to house smaller items such as sneakers or shoes. Alternatively, rather than the double over-the-shoulder strap, a single messenger-bike type carry strap may be possible. The material may be tough and durable, while still being foldable. It may be tough and durable in order to withstand being cut or torn with a standard scissor or knife, while still being foldable in order to collapse into a cylinder form. Examples of material may be any one of, or at least one of, canvas, leather, nylon, ripstop nylon, or any cut, abrasion, and tear-resistant material. Alternatively, the material may not be cut, abrasion, or tear resistant, and just be foldable or pliable. In some embodiments, the back-pack 10 may not need to be folded into a cylindrical form during active riding, and instead, just worn over the shoulders of the rider as-is. While drag may be increased in comparison to the foldable (cylindrical) form, the drag may not be significant enough to warrant a foldable embodiment.

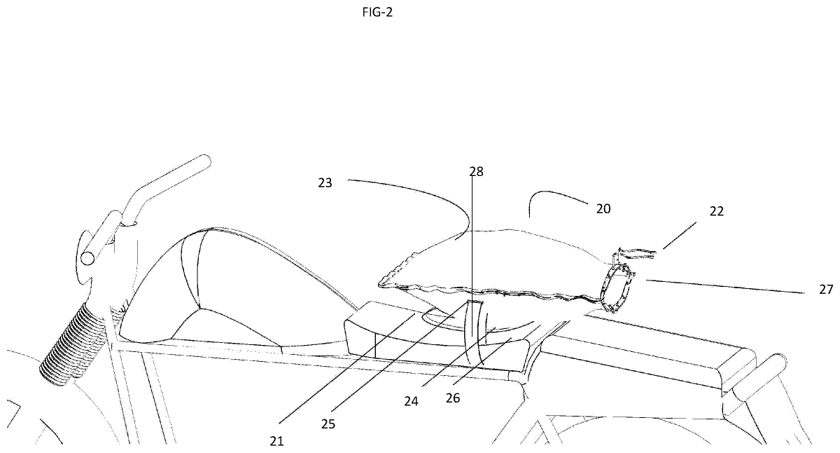

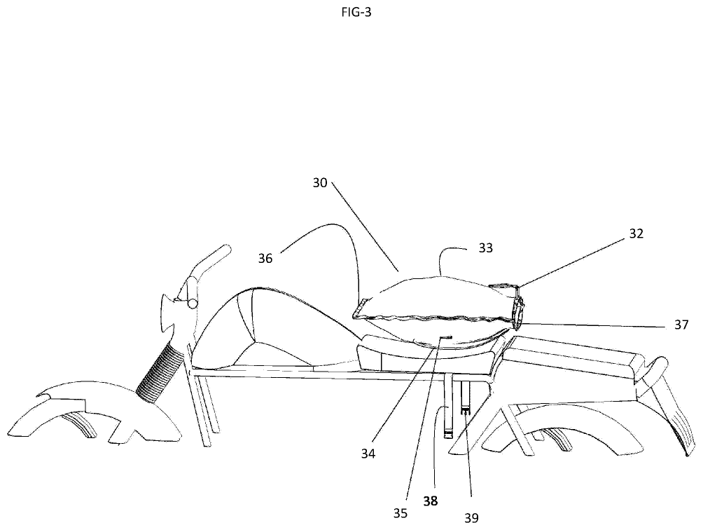

Now in reference to FIG. 2 and FIG. 3. FIG. 2 depicts a side-view of the back-pack mounted onto a seat of a motorcycle in accordance with an aspect of the invention and FIG. 3 depicts a side-view of the back-pack un-securely mounted onto a seat of the motorcycle in accordance with an aspect of the invention. As depicted in FIGS. 2 and 3, the apparatus provides for a mount deterrence by comprising: a back-pack 20, 30 of foldable material with a back surface, a front surface 23, 33, one side 24, 34, another side, a slit 25, 35 on each side, a bottom surface 26, 36, a top surface with a draw-string 22, 32 opening for accessing at least one compartment, and at least one over-the-shoulder strap disposed on the back surface; the back-pack 20, 30 with the draw-string 22, 32 drawn, wherein said back-pack 20, 30 back surface to rest on a top surface of a seat 21, 31 of the motorcycle; a first strap 28, 38 affixed proximal to a first side of the seat 21, 31 of the motorcycle and said first strap 28, 38 terminating with a hook 39 and a second strap affixed proximal to a second side of the seat 21, 31 of the motorcycle and said second strap terminating with a buckle or loop; each of the first strap 28, 38 and second strap inserted through each of the slits 25, 35 disposed on each of the sides 24, 34 of the back-pack 20, 30 gaining access into the at least one compartment of the back-pack 20, 30 and the hook 39 of the first strap 28, 38 hooked into the buckle or loop of the second strap by access through the un-drawn top opening 27, 37 of the back-pack 20, 30; and draw the top portion 27, 37 of the back-pack 20, 30 closed and lock the top portion 20, 30 closed securing the back-pack 20, 30 housing the helmet on the seat 21, 31 of the motorcycle in an unattended state and deterring unauthorized mounting of the motorcycle and restricting access into the compartment for access to at least one of the helmet and/or hook 39 for un-hooking the straps 28, 38 and removing the back-pack 20, 30 from the seat 21, 31 of the motorcycle by anyone unauthorized.

In another embodiment, the apparatus for deterring mounting comprises: a first strap 28, 38 affixed proximal to a first side of a seat 21, 31 of the motorcycle and said first strap 28, 38 terminating with a hook 39 and a second strap affixed proximal to a second side of the seat 21, 31 of the motorcycle and said second strap terminating with a buckle or loop; each of the first strap 28, 38 and second strap inserted through each of a slit 25, 35 disposed on each side 24, 34 of a back-pack 20, 30 gaining access into at least one compartment of the back-pack 20, 30 and the hook 39 of the first strap 28, 38 hooked into the buckle or loop of the second strap by access through an un-drawn top opening of the back-pack 20, 30; and draw the top portion 27, 37 of the back-pack 20, 30 closed and lock the top portion 27, 37 closed securing the back-pack 20, 30 housing a helmet on the seat of the motorcycle in an unattended state and deterring unauthorized mounting of the motorcycle and restricting access into the compartment for access to at least one of the helmet and/or hook 39 for un-hooking the straps 28, 38 and removing the back-pack 20, 30 from the seat 21, 31 of the motorcycle by anyone unauthorized.

While not shown, some embodiments may further comprise a left and right flap that disposed on the front surface of the back-pack, wherein the right and left flap hook each other by at least one of a hook, loop, or buckle. The flaps may be un-hooked and drape each side of the motorcycle, covering the sides of the seat, and possibly portions of the engine or other components residing below the seat. This drape or skirt may create an illusion of a larger apparatus, and as a result, create a greater deterrence to sitting, straddling, or mounting of the motorcycle. Advantageously, the flaps hooked up may further aid in creating a bundled cylindrical form of the back-pack while over the shoulders of a rider or motorcyclist during riding. Also not shown, the sides of the back-pack 20, 30 may be disposed with a hook on one side and a loop or buckle on the other side of the back-pack, enabling a user to fold-in the back-pack and hook or buckle the two sides together to form the bundled cylindrical form mentioned above.

As shown, the back-pack 20, 30 while mounted onto the seat 21, 31, may convex (hump) as a result of the helmet being housed within the inner compartment of the back-pack 20, 30. The hump or protrusion is what serves as the physical impediment to sitting, straddling, or mounting of the stationary and unattended motorcycle. In some embodiments, rather than a helmet, any number of large objects may be housed within the compartment of the back-pack 20, 30 to cause the seat-mounted back-pack to hump, and hence, deter a mounter. The back-pack 20, 30 may have a form factor configured to house any spherical, cubic, rectangular, elliptical, semi-spherical, or semi-elliptical object large enough to cover a substantial portion of a surface of the motorcycle seat 21, 31.

While not shown, the back-pack may contain multiple compartments. The slits on either side may access the same primary compartment that is also accessed by the top portion or opening of the back-pack. In some embodiments, this inner compartment may further comprise additional compartments for storing smaller items such as a mobile phone, keys, wallet, etc. Alternatively, a larger zippered compartment may reside at the bottom portion of the back-pack that may be accessed from within the primary compartment or from the outside of the back-pack. Obviously, due to the fact that the back-pack is left unattended while mounted on the surface of the seat, restricting access to compartments from within a locked primary compartment is advantageous, versus gaining access from the outside. Alternatively, outer access may still be viable if coupled with a locking means.

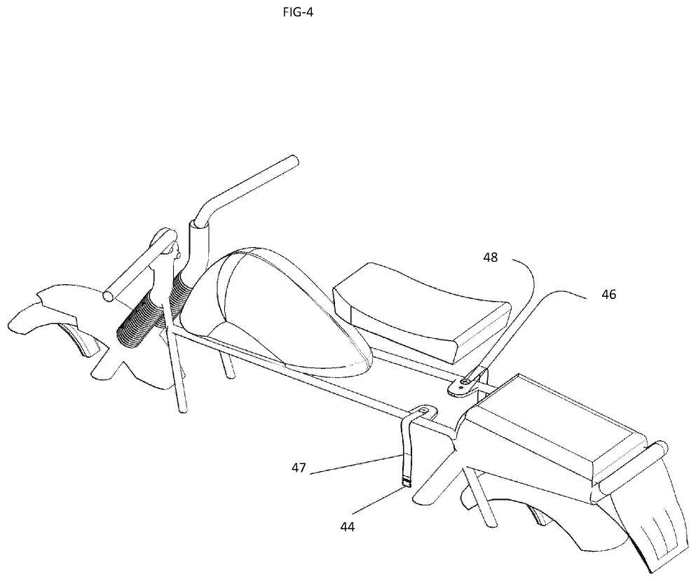

FIG. 4 depicts a close-up illustrating how the straps are affixed proximal to a side of a seat in accordance with an aspect of the invention. As shown, additional mounting plates are not necessary in order to affix the straps 42 proximal to a side of a seat 46. The straps 42 are configured on an end opposing the hook, loop, or buckle 44 with an end piece 47 disposed with a screw hole. This end piece 47 simply co-opts the existing screw hole 48 disposed on a bottom surface or side of a seat 46 and the existing screw hole 49 disposed on a top surface of the frame or chassis, proximal to a side of the seat 46. The end piece 47 would simply be screwed in between the seat screw hole 46 and the top surface of the chassis or frame screw hole 49. Once screwed or installed, there will be no need to re-install and the strap 42 would simply dangle while the motorcycle is not strapped-mounted with the back-pack. It is conceived that the straps 42 would be of a certain length in order to comfortably strap and buckle in within the inner compartment of the back-pack, while not being long enough to create a nuisance while dangling as the user is riding the motorcycle.

While not shown, a strap mounting plate may be used to mount the straps on a frame or chassis of the motorcycle, proximal to a side of a seat of the motorcycle. There may be one strap mounting plate on each side of the chassis or frame, proximal to the seat. The plate may comprise screw holes on each corner for accepting washer and screws to securely mount the plate on the surface of the chassis or frame. Preferably, the plate would be mounted on the very terminal edge of both sides of the chassis or frame. While not shown, alternatively, a single mount plate may be mounted in the center of the bottom surface of the seat, extending therefrom two straps on either side of the plate.

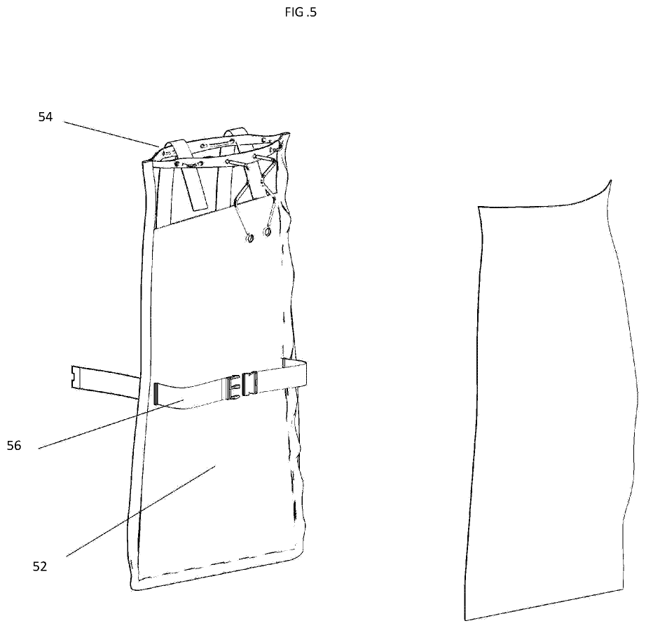

The terminal end of the straps 42 or distal end of the straps 42 terminate in either a hook 44 or buckle/loop 44. The strap 42 length may vary, but should be long enough to be able to insert through the corresponding slit on the side of the back-pack while mounted back-surface down on the seat of the motorcycle. Additionally, the strap 42 length should be long enough to be able to extend through the inner single compartment 52 of the back-pack from a top-portion 54 opening and hook the straps 56 from both sides together in the center of the inner single compartment (FIG. 5 depicting the inner compartment of the back-pack in accordance with an aspect of the invention). While not shown in FIG. 4 or 5, the hardware or mounting kit may also provide for two additional plate mounts to be mounted on each side of the motorcycle, proximal to the seat, thereby allowing the user to hook or secure the distal ends of the straps (hook, loop, or buckle) to prevent the straps from dangling and swaying during operation.

In yet another embodiment, the strap mounting plate may be simply a plate mount without strap and mounted on the side of the motorcycle and proximal to the seat. The straps may be permanently affixed to the back-pack itself and simply buckled and locked to the complementary portion of the plate mount while stationary, and buckled together or to some other portion of the back-pack while riding. The advantage of this particular embodiment is that the straps avoid dangling during riding, as with the other embodiments. However, the disadvantage is that they would require essentially three points of locking during stationary/unattended state, as opposed to just simply one as with the other embodiments.

The strap mounting plate 42 is installed once by the user prior to use and no other installation or hook-up is required on a use-by-use basis. The plate 42 may be delivered, purchased separately as a hardware kit, or purchased with the back-pack. The kit may include a variety of items necessary for mounting—the kit and mounting similar to a standard after-market saddle bag. The kit may include at least one plate, screws, and washers.

Preferably, this hooking of straps 56 and mounting of the back-pack on the seat of the motorcycle is done prior to storing the helmet within the inner single compartment 52 of the back-pack. As shown in FIG. 5, the straps 56 are hooked in the center, laying flat on the bottom surface of the inner compartment 52. It should be appreciated by a person of ordinary skill that the straps 56 may be hooked anywhere in the inner compartment 52, so long as it is accessible by a user from the top portion 54 opening for hooking and un-hooking, along with not impeding storage of the helmet or any deterring object within the inner compartment 52.

The straps may further have an additional securing or hooking means onto complementary portion disposed or fixed on the surface of the inner lining to prevent sliding of the back-pack through the slits. Alternatively, the straps may directly secure or hook onto this complementary portion disposed on the inner lining to prevent sliding.

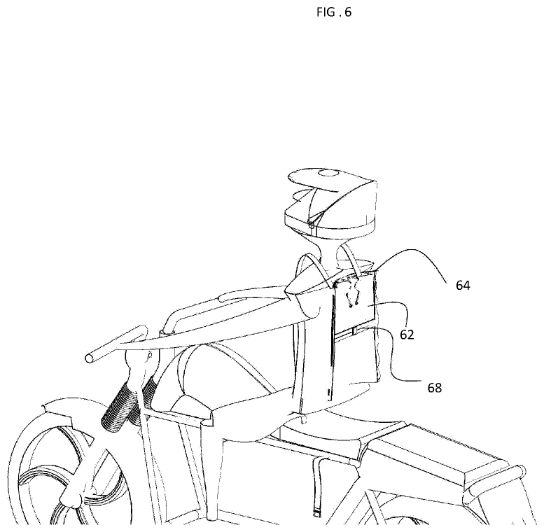

FIG. 6 depicts the back-pack worn over the shoulders of a motorcyclist while the motorcycle is in operation. As shown, the back-pack 62 is depicted as a tote-bag with a cinch-draw top portion 64 with its sides 66 folded in forwardly and secured into a compact or cylindrical form by a side buckle 68. In this compact or cylindrical form, the back-pack offers minimal wind resistance while the user is operating the motorcycle. Alternatively, the sides 66 may fold backwardly and secured into the cylindrical form by a side buckle 68. While not shown, the cinch-draw top portion 64 may additionally have a flap to cover over the top portion 64 and optionally buckle to the same side buckle 68, or optionally, to a dedicated buckle. It is also to be appreciated that a buckle could be replaced with any standard securing means known in the art, such as hooks, loops, carabiners, etc. These securing means may also apply to the terminal distal ends of the straps within the inner compartment of the back-pack to secure the straps and securely mount the back-pack onto the top surface of the seat for providing mount deterrence (FIG. 5).

While not shown in FIG. 6, alternative styles or form-factors may be applied to the back-pack. The only design constraint is that the top portion and inner compartment needs to be large enough or expand enough to accommodate the size and shape of a helmet to form a deterring bulge or hump. Alternatively, any other similarly sized and shaped object may be housed in the back-pack to form comparably deterring bulge or hump. Other styles and form factors may be a back-pack with a zippered front face or a buckled top flap. Moreover, alternatively, any one of the tote, zippered, or buckled back-pack may not fold in to form the cylindrical form—and remain unfolded on the back of the user—even at the risk of increasing wind resistance during operation.

While also not shown in FIG. 6, any number of additional compartments accessible from within or from outside may be provided. For instance, a bottom portion that is zippered may be practical for storing items, such as shoes, etc. Additionally, smaller compartments within the larger inner compartment may be provided for storage of smaller items, such as a wallet, key, mobile phone, etc.

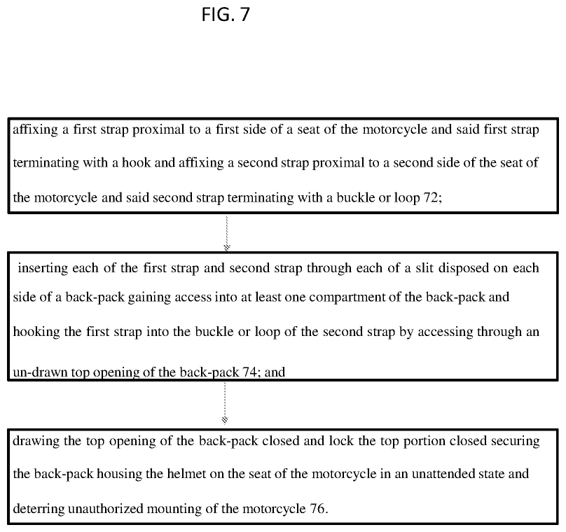

FIG. 7 depicts a method flow diagram in accordance with an aspect of the invention. A method for preventing unauthorized straddling of a motorcycle comprises the steps of: (1) affixing a first strap proximal to a first side of a seat of the motorcycle and said first strap terminating with a hook and affixing a second strap proximal to a second side of the seat of the motorcycle and said second strap terminating with a buckle or loop 72; (2) inserting each of the first strap and second strap through each of a slit disposed on each side of a back-pack gaining access into at least one compartment of the back-pack and hooking the first strap into the buckle or loop of the second strap by accessing through an un-drawn top opening of the back-pack 74; and (3) drawing the top opening of the back-pack closed and lock the top portion closed securing the back-pack housing the helmet on the seat of the motorcycle in an unattended state and deterring unauthorized mounting of the motorcycle 76.

In a preferred embodiment, the back-pack is comprised of at least one of a nylon, canvas, and/or leather. Any one of a style or form-factor may be used, so long as it can house an object the size and shape of a helmet and lock from at least one outer point. Preferably, an additional left and right flap cover may be disposed on the front face or surface that hook in to unite and form the cylinder while worn in the operational state. In a stationary and unattended state, the flaps may un-roll to drape down over the sides of the seat, much like a drape or skirt, to further conceal the motorcycle. Alternatively, the back-pack may fold in and create the cylindrical form without the front-faced flaps, and just have the sides of the back-pack rolled or folded in.

The straps, extending from the under-seat mounted plate, may be each slipped through a specifically conformed slit on each side of the back-pack, hooking to each other within an inner compartment to securely mount the backpack on the seat of the motorcycle. Each specifically conformed slit is just wide enough for passage of the strap with any one of a terminal end (hook, loop, or buckle) and is specifically designed to prevent a persons hand from passing through. The terminal end of each strap is hooked within the inner compartment through the top opening portion. Once the straps are hooked and the back-pack is securely mounted onto the seat, the user may place his or her helmet within the inner compartment. The back-pack may be accessed by the user through a top opening portion that is cinch-drawn. Alternatively, access may be gained for hooking/un-hooking the straps and placing/removing the helmet through a top opening flap, front-face zipper or hook. Given the expense of the helmet and a need to prevent removal of the back-pack from the seat by a mounter, it is imperative to have any one of a locking means on at least one of a top opening portion, cinch-draw, front face zipper or hook, accessing the inner compartment. It is to be appreciated that any number of compartments, with or without separate locking means, may be provided without departing from the scope of the invention. However, the inner compartment housing the helmet and securing straps must be lockable by any type of locking means, preferably by a standard lock, sold with or separately.

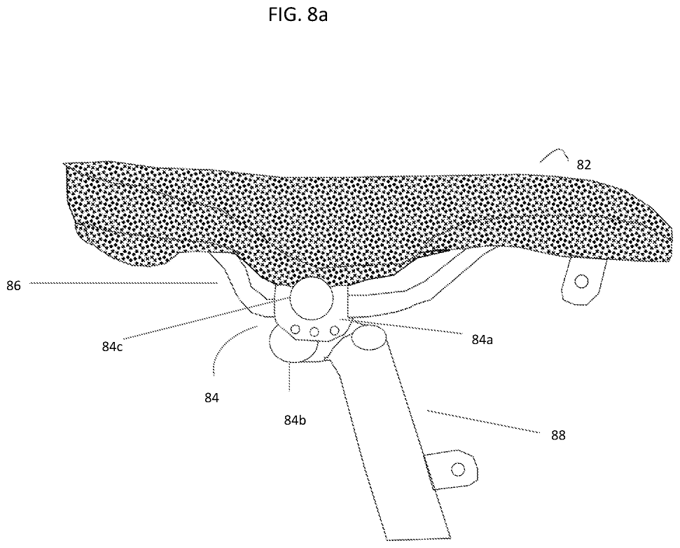

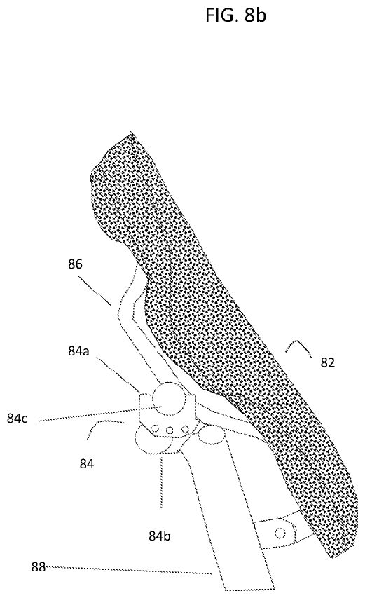

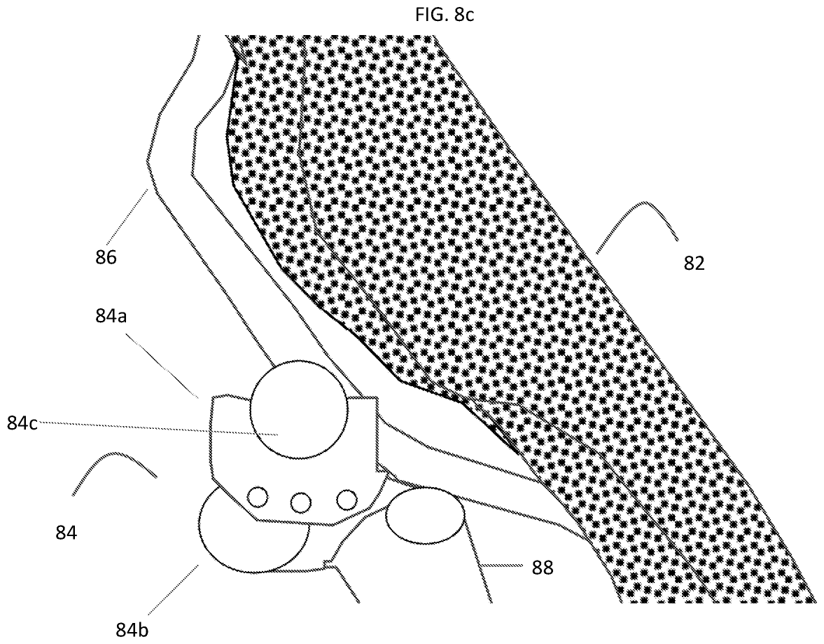

FIGS. 8a, 8b, and 8c depict a mount deterrence apparatus in accordance with an aspect of the invention. FIG. 8a depicts a wide-angle perspective of the saddle area of a two-wheel conveyance, particularly a bicycle. As shown, the bicycle is in a mount or ready-for-use state, suggested by the saddle 82 being in its normal position ready to accommodate a seated user. FIG. 8b also depicts a wide-angle perspective of the same saddle area of the same bicycle, however, with the saddle 82 pivoted down in order to deter unauthorized mounting. It bears noting that a skilled artisan may contemplate other directions of saddle 82 pivoting, such as pivoting up, down, or sideways, accomplishing a similar end effect of deterring unauthorized mounting. FIG. 8c depicts a close-up perspective of the under-saddle area, illustrating additional components, such as the saddle block 84, first block element 84a, second block element 84b, saddle glide 86, and saddle post 88. As shown, the first block 84a may be coupling the saddle 82 with the second block 84b and configured to pivot from the second block 84b by a point of articulation or pivot 84c—in order to enable a stow-away of the saddle 82.

The articulation point 84c on the block 84 may comprise any number of standard hinges or joints, allowing the saddle 82 a freedom of motion sufficient to deter mounting. The hinge 84c may also be disposed on the back-end of the block 84 enabling an upward-pivot of the saddle 82. A person of ordinary skill in the art should also appreciate the fact that once the saddle 82 is in a stowed-away or pivoted position during a stationary state, the saddle 82 may be locked into position until unlocked by the authorized user. Any number of standard built-in or accessory locks may be implemented. The lock may be auto-generated, rather than user-initiated. Whether auto-generated or user-initiated, unlocking may occur upon rental session initiation while docked/stationary, or upon motion detection. While not shown, the articulation point or hinge 84c may also be disposed between the block 84 (single, unitary block) and the saddle post 88 for enabling saddle 82 stowing/pivoting in either direction.

In one embodiment, a two-wheeler mount preclusion apparatus comprises a saddle-post block 84 coupling a saddle 82 with a post 88, wherein said block 84 comprises at least a first saddle portion (first portion) 84a and second post portion (second portion) 84b; a point of articulation 84c on the block 84, said point adjoining the first saddle portion 84a with the second post portion 84b of said block 84; and when manipulated, allowing for at least a degree of rotation of the first saddle portion 84a, wherein the rotation of the first saddle portion 84a rotates the saddle 82 into a mount-precluded state. Optionally, a clamp or screw (optionally, any type of tool of manipulation) at the point of articulation 84c of said saddle-post block 84a may be available for manipulation, allowing for at least a degree of rotation of the first saddle portion 84a or complete/unitary block 84, wherein the rotation of the first saddle portion 84a or block 84 rotates the saddle 82 into a mount-precluded state.

While not shown, in another embodiment, a two-wheeler mount preclusion apparatus comprises: a saddle-post block coupling a saddle with a post; a point of articulation at an end of the block proximal to a handle bar, said point adjoining the block with a saddle post; and when manipulated, allowing for at least a degree of rotation of the block, wherein the rotation of the block rotates the saddle into a mount-precluded state. Also, optionally, a clamp or screw at the point of articulation 84c of said saddle-post block 84a may be available for manipulation, allowing for the first saddle portion 84a to rotate the saddle 82 into a mount-precluded state.

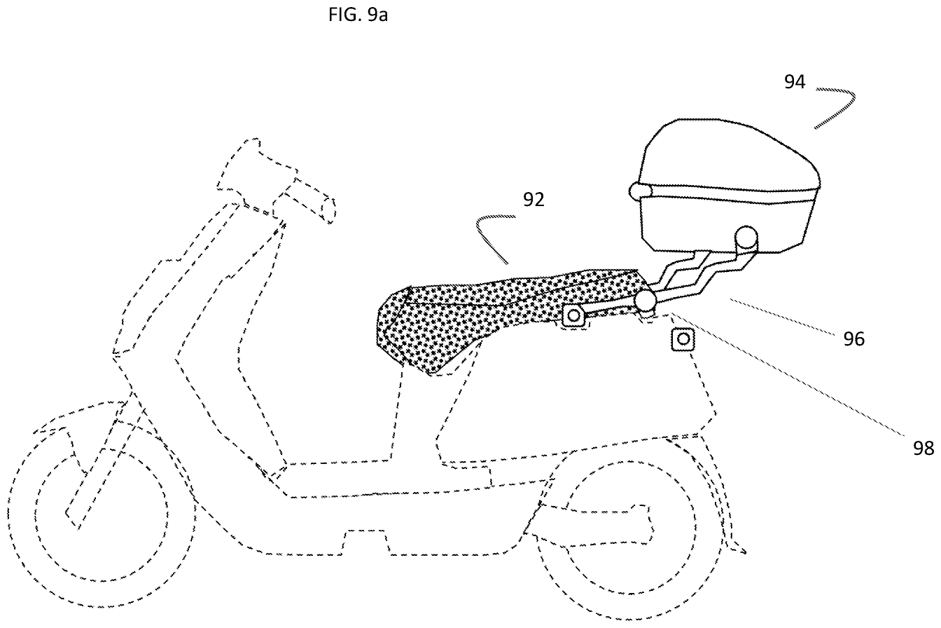

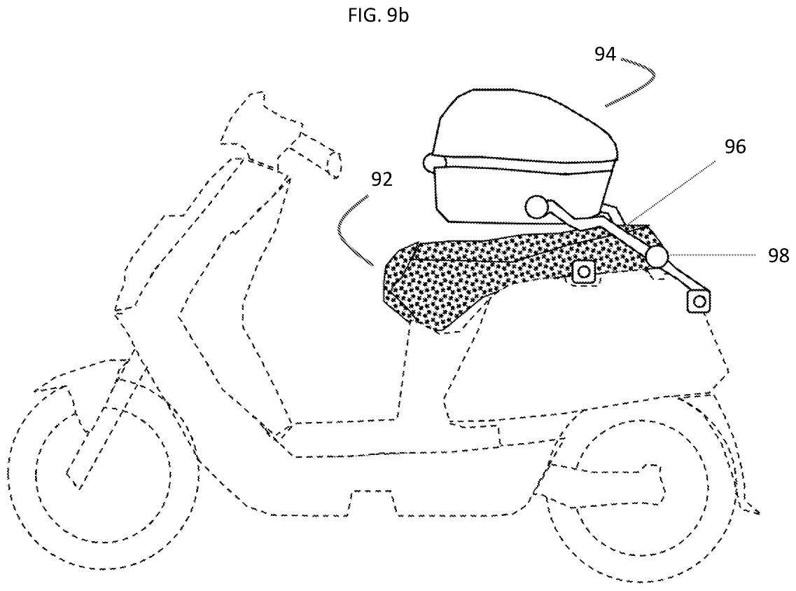

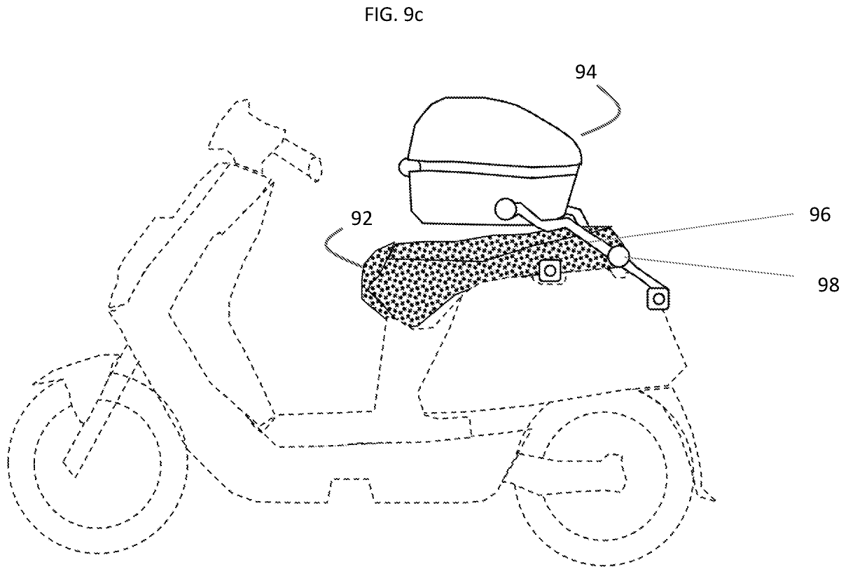

FIGS. 9a, 9b, and 9c depict a mount deterrence apparatus in accordance with an aspect of the invention. FIG. 9a depicts a wide-angle perspective of a two-wheel conveyance, particularly a moped. As shown, the moped is in a mount or ready-for-use state, suggested by the trunk 94 being in its normal position and not occluding the saddle 92. FIG. 9b also depicts a wide-angle perspective of the same moped, however, with the saddle 92 occluded by the pivoted down trunk 94 in order to deter unauthorized mounting. FIG. 9c depicts a close-up perspective of the trunk brace 96 hinge or articulation point 98 located at a mid-point of the trunk brace 96. As shown, the trunk 94 pivots up and over the saddle 92 and may lock into position until ready for authorized use. Locking and unlocking mechanisms as described before may be implemented. Manipulation may occur by motion of a tool: clamp, lever, or screw, etc.

In one embodiment, a two-wheeler mount preclusion apparatus comprises: a trunk brace 96, said trunk brace 96 configured to securely position a trunk 94 over a seat or saddle 92 on a top side; a point of articulation at a mid-point of the brace; and the point of articulation 98, when manipulated, allowing for at least a degree of rotation of the brace 96, wherein the rotation of the brace 96 rotates the trunk 94 over the saddle 92, thereby precluding mounting.

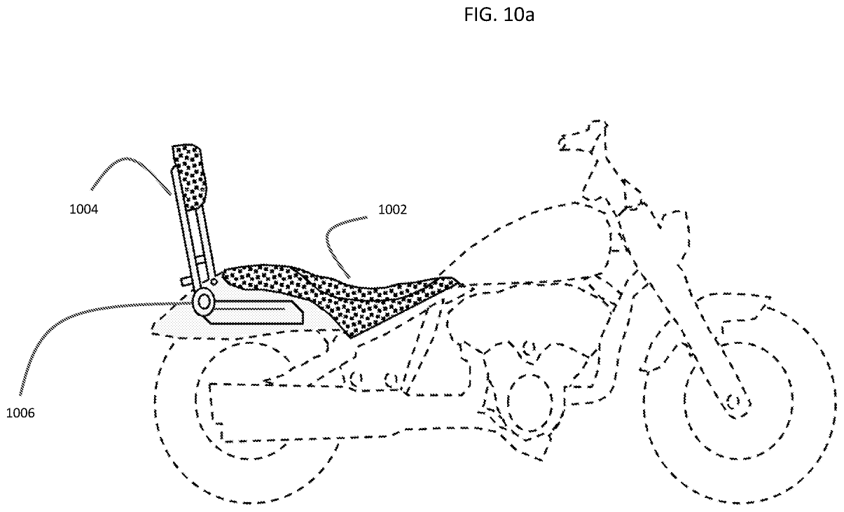

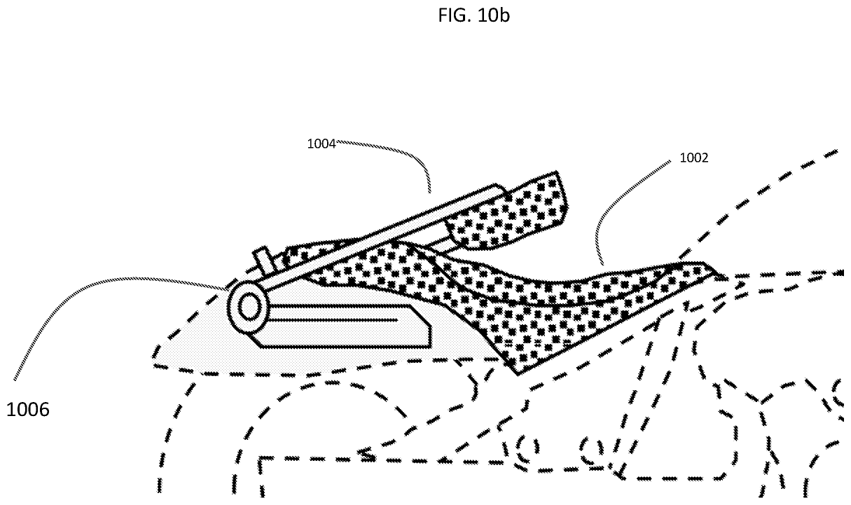

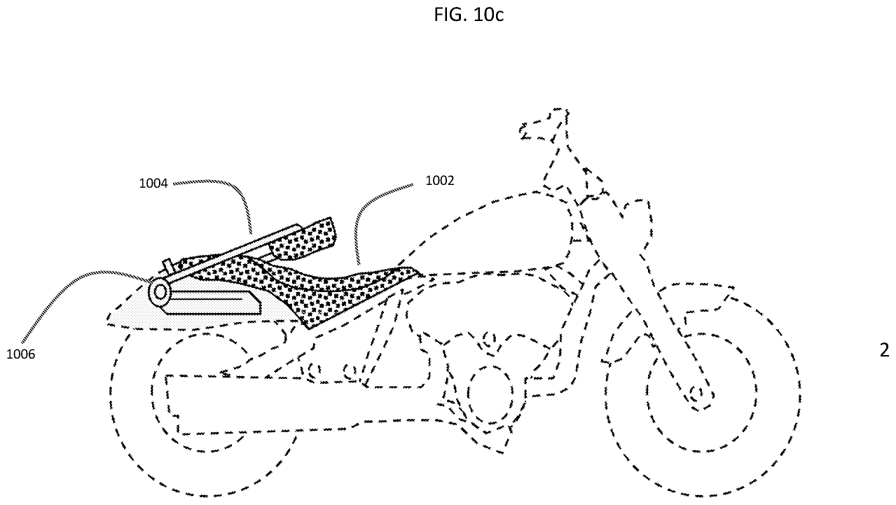

FIGS. 10a, 10b, and 10c depict a mount deterrence apparatus in accordance with an aspect of the invention. FIG. 10a depicts a wide-angle perspective of a two-wheel conveyance, particularly a cruiser, in a mount or ready-for-use state. FIG. 10b also depicts a wide-angle perspective of the same cruiser, however, with the saddle 1002 occluded by the pivoted down back-rest 1004 in order to deter unauthorized mounting. In another embodiment, while not shown, the saddle 1002 may pivot up to serve deterrence, rather than the back-rest 1004. FIG. 10c depicts a close-up perspective of the back-rest hinge or articulation point 1006.

In one embodiment, a two-wheeler mount preclusion apparatus comprises: a point of articulation 1006 between a back-rest 1004 and a seat or saddle 1002; and the point of articulation 1006, when manipulated, allowing for at least a degree of rotation of the back-rest 1004, wherein the rotation of the back-rest 1004 renders the two-wheeler into a mount-precluded state. Locking and unlocking mechanisms as described before may be implemented. Manipulation may occur by motion of a manipulation tool: clamp, lever, or screw, etc.

In another embodiment, while not shown, the two-wheeler mount preclusion apparatus comprises: a point of articulation between a rear fender and a seat or saddle; and the point of articulation 1006, when manipulated, allowing for at least a degree of rotation of the rear fender or saddle, wherein the rotation of either the rear fender or saddle renders the two-wheeler into a mount-precluded state.

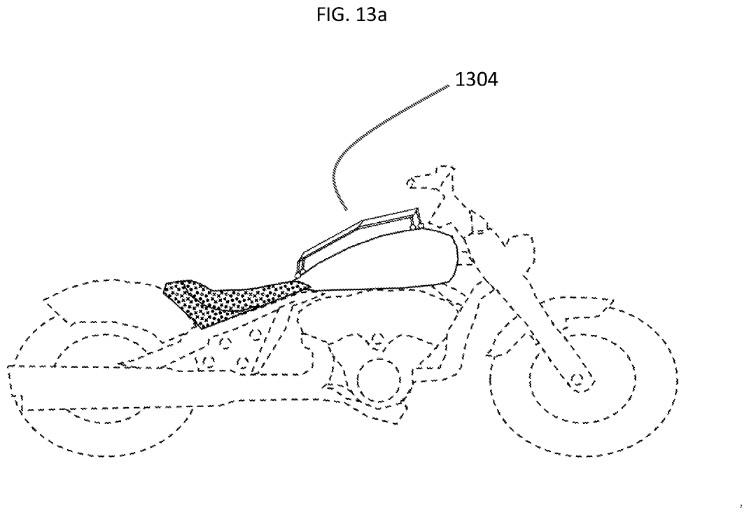

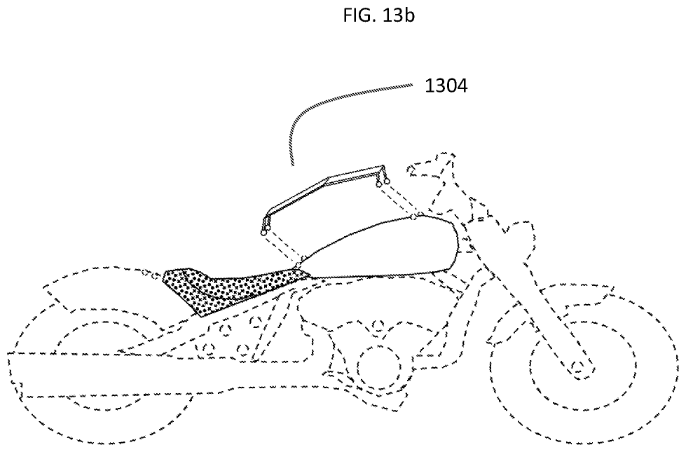

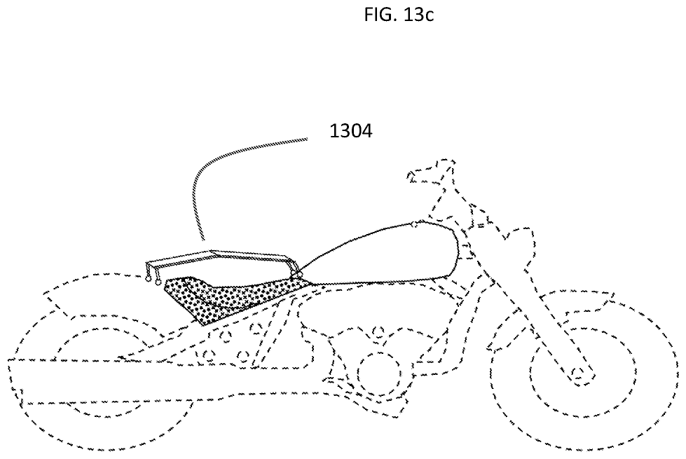

FIGS. 13a, 13b, and 13c depict a mount deterrence apparatus in accordance with an aspect of the invention. The cruiser may be adapted for a detachable mount-deterrence element affixed to any one of a chassis, frame, tank, tail, etc., of the cruiser and fitted over the saddle for achieving a mount-deterred state. As shown, in FIG. 13a, the detachable element is affixed onto the tank of the cruiser during cruising, and then detached (FIG. 13b) for fitting over the saddle area of the cruiser during a stationary/mount-deterred state (FIG. 13c). The element may be any one of a metallic or plastic material with an aerodynamic form-factor during an affixed/cruising state, while protrusive enough to deter mounting during a stationary/mount-deterred state.

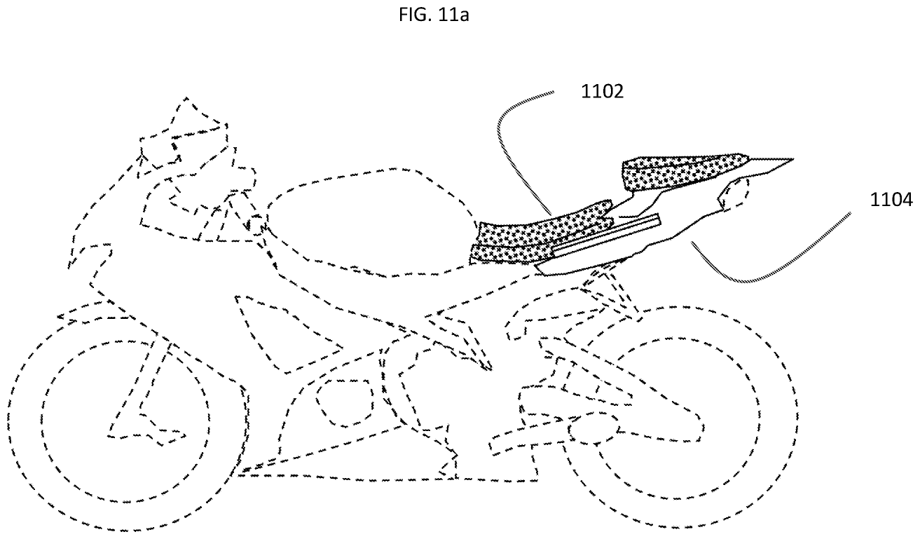

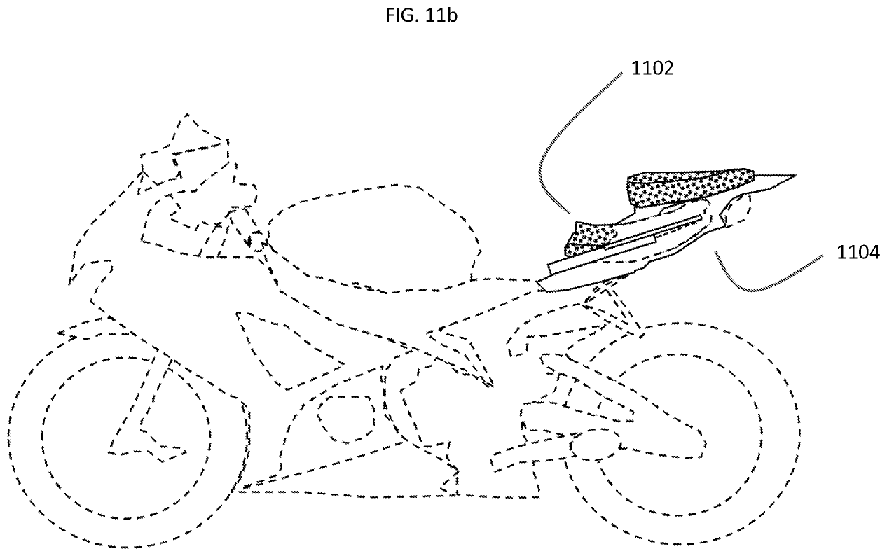

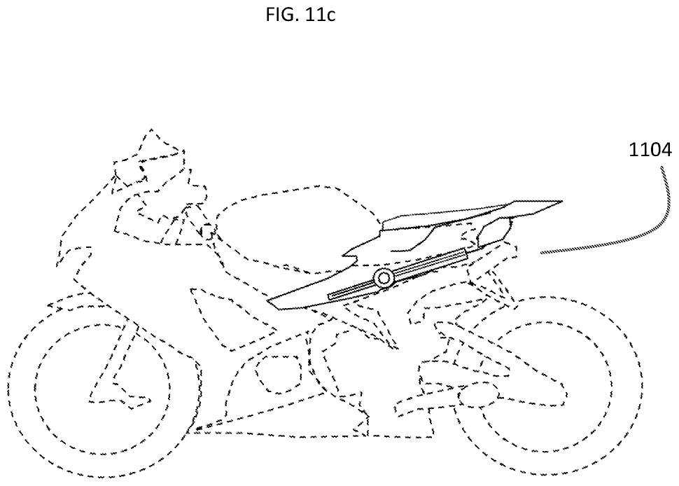

FIGS. 11a, 11b, and 11c depict a mount deterrence apparatus in accordance with an aspect of the invention. FIG. 11a depicts a wide-angle perspective of a two-wheel conveyance, particularly a sports bike. As shown, the bike is in a mount or ready-for-use state, suggested by the saddle 1102 and tail 1004 being in its normal position ready to accommodate a seated user. FIG. 11b also depicts a wide-angle perspective of the same saddle area of the same bike, however, with the saddle 1102 slid on a guide rail running the length of the tail in order to conceal the saddle 1102 and deter unauthorized mounting. FIG. 11c depicts another close-up perspective of the saddle and tail area of an identical conveyance, featuring a similar track and guide rail as FIG. 11b, but configured for the tail 1104 sliding down to at least partially conceal the saddle.

In one embodiment, a two-wheeler mount preclusion apparatus comprises: a sub-frame adjoined to a tail storage such that a gap exists between the tail storage 1104 and sub-frame; a saddle or seat 1102 with a bottom surface disposed with a block slidably interposed on a rail on a top surface of the sub-frame; and said saddle 1102 sliding on the rails via the block to a point under the tail storage occluding at least a portion of the saddle 1102, thereby precluding mounting. Locking and unlocking mechanisms as described before may be implemented. Manipulation may occur by motion of a tool, such as a clamp, lever, screw, etc., for sliding or pivoting of the saddle for mount deterrence. In another embodiment, the block, track, and rail assembly may be configured for the tail 1104 to slide down to conceal the saddle 1104 for achieving mount preclusion.

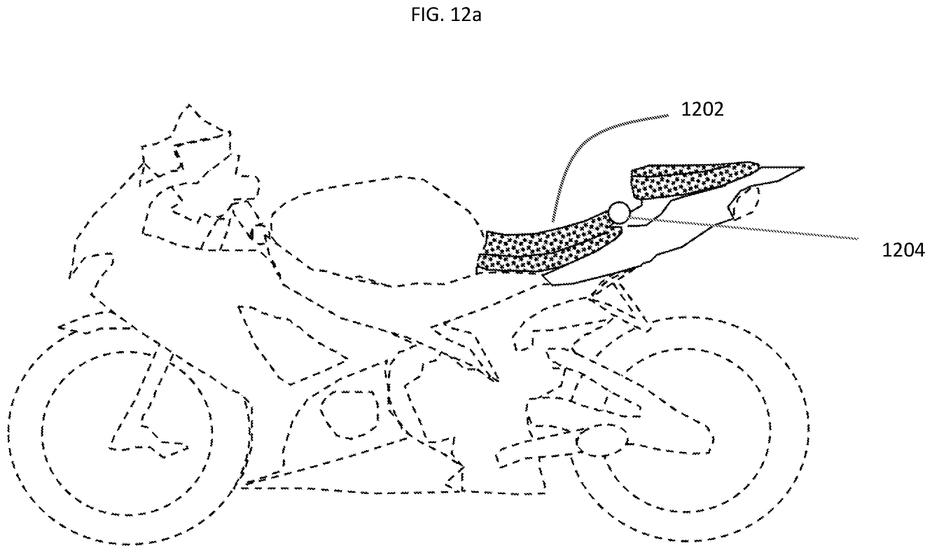

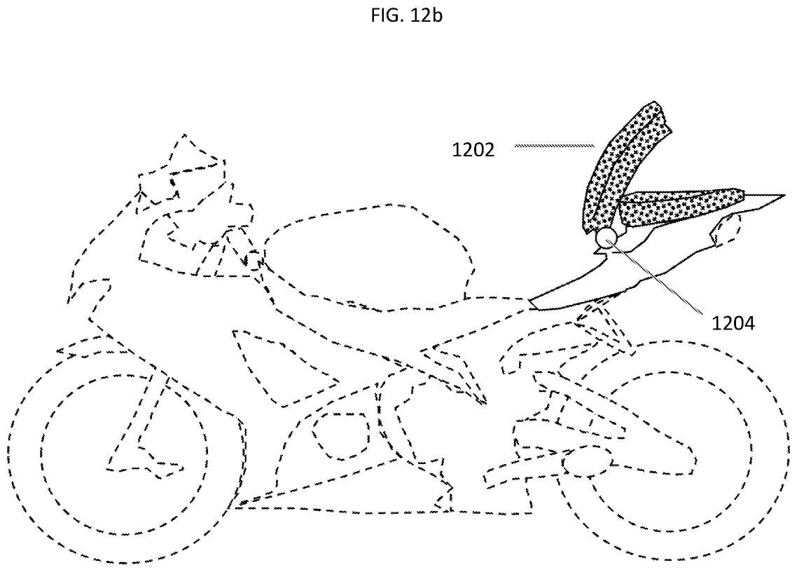

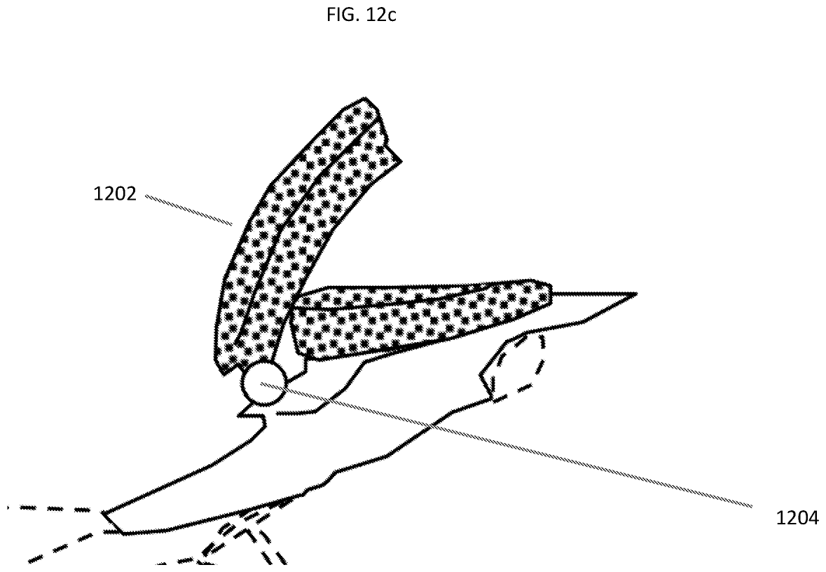

As illustrated in FIGS. 12a-12c, the sports bike saddle 1202 may also flip up or pivot up. Once flipped/pivoted and locked into place, the saddle 1202 becomes inaccessible. FIG. 12a depicts a wide-angle perspective of a two-wheel conveyance, particularly a sports bike, in the mount-ready state. FIG. 12b depicts a wide-angle perspective of the same sports bike with the saddle 1202 pivoted over for deterring unauthorized mounting. FIG. 12c depicts a close-up perspective of saddle-tail articulation/pivot/hinge point 1204.

In one embodiment, a two-wheeler mount preclusion apparatus comprises: a saddle or seat 1202 positioned between a tank at a first end and a tail at a second end, wherein the tail-end features a point of pivot 1204, when manipulated, allowing for at least a degree of rotation of the saddle 1202, rendering the two-wheeler into a mount-precluded state. Locking and unlocking mechanisms as described before may be implemented.

In another embodiment, while not shown, a two-wheeler mount preclusion apparatus comprises: a saddle or seat 1202 positioned between a tank at a first end and a tail at a second end, wherein the tail-end features a point of rotation, when rotated, allowing for at least a degree of rotation of the saddle 1202, rendering the two-wheeler into a mount-precluded state. Locking and unlocking mechanisms as described before may be implemented. Optionally, manipulation may occur by motion of a manipulation tool: clamp, lever, screw, etc., for rotation/pivoting of the saddle for mount-deterrence.

The foregoing descriptions of specific embodiments of the invention have been presented for purposes of illustration and description. They are not intended to be exhaustive or to limit the invention to the precise forms disclosed. Modifications and variations are possible in light of the above teaching. The embodiments were chosen and described in order to explain the principles and the application of the invention, thereby enabling others skilled in the art to utilize the invention in its various embodiments and modifications according to the particular purpose contemplated. The scope of the invention is intended to be defined by the claims appended hereto and their equivalents.

What is claimed is:

1. A two-wheeler mount preclusion apparatus, said apparatus comprising:
a saddle-post block coupling a saddle with a post;
a point of articulation disposed on the block; and
a tool of manipulation at the point of articulation of said block, when manipulated, allowing for at least a degree of rotation of the saddle, wherein the rotation of the saddle renders the two-wheeler into a mount-precluded state.

2. The apparatus of claim 1, wherein the block is further comprised of a first saddle portion and a second post portion, wherein the saddle pivots on a point of articulation between the first saddle portion and the second post portion.

3. The apparatus of claim 1, wherein the mount precluded state is in effect until a newly initiated rental or riding session.

4. The apparatus of claim 1, wherein pivot of the saddle occurs only after an end of a rental or riding session and/or start of a new rental or riding session.

5. A two-wheeler mount preclusion apparatus, said apparatus comprising:
a trunk brace;
said trunk brace configured to securely position a trunk and/or saddle on a top side of a two-wheeler frame;
a point of articulation on the brace; and
a manipulation tool at the point of articulation, when manipulated, allowing for at least a degree of rotation of the brace, wherein the rotation of the brace pivots the trunk over the saddle, rendering the two-wheel conveyance into a mount precluded state.

6. The apparatus of claim 5, wherein the mount precluded state prevents rotation of the trunk brace until an end of a rental or riding session and/or a newly initiated rental or riding session.

7. A two-wheeler mount preclusion apparatus, said apparatus comprising:
a point of articulation between a back-rest and a saddle; and
a tool of manipulation at the point of articulation, when manipulated, allowing for at least a degree of rotation of the back-rest or saddle, wherein the rotation of the back-rest or saddle renders the two-wheeler into a mount-precluded state.

8. The apparatus of claim 7, wherein the mount precluded state prevents rotation of the back-rest or the saddle until an end of a rental or riding session and/or a start of a newly initiated rental or riding session.

9. A two-wheeler mount preclusion apparatus, said apparatus comprising:
a gap between a tail and frame;
a tail with a bottom surface disposed with a block slidably interposed on a rail on a top surface of the frame; and
said tail sliding on the rails via the block over the saddle occluding at least a portion of the saddle, thereby precluding mounting.

10. The apparatus of claim 9, wherein the saddle is entirely concealed by the sliding tail.
